(19) United States
(12) Patent Application Publication
(10) Pub. No.: US 2013/0171918 A1
(43) Pub. Date: Jul. 4, 2013

(54) MACHINING APPARATUS

(71) Applicant: GUO-HE HUANG, Shenzhen City (CN)

(72) Inventor: GUO-HE HUANG, Shenzhen City (CN)

(21) Appl. No.: 13/662,625

(22) Filed: Oct. 29, 2012

(30) Foreign Application Priority Data
Dec. 28, 2011 (CN) 201110447329.9

(51) Int. Cl. B08B 15/00

(52) U.S. Cl. 454/49

(57) ABSTRACT

A machining apparatus includes a machine and robot. The machine includes a top plate, a ventilation portion, an exhaust pipe, a fan, a pipe and a jig secured to the top plate. The jig is configured for securing a workpiece to be processed. The robot is configured for polishing and cutting the workpiece. The jig defines a cutout between a top surface of the jig and the top plate. The pipe communicates with the cutout. The ventilation portion communicates with the exhaust pipe and is located between the pipe and the exhaust pipe. The fan secured to the ventilation portion. The fan guides air flows into the pipe through the cutout and discharges the air out of the machine via the ventilation portion and the exhaust pipe.

### BACKGROUND

1. Technical Field

The present disclosure relates to machining apparatuses, and particularly to a machining apparatus with a dust cleaning structure.

2. Description of Related Art

When workpieces are processed in a machining apparatus, a number of processes, such as polishing and cutting, may generate dust particles. If the dust particles cannot be cleaned in time, the dust particles may be collected in the machining apparatus, which may affects the appearance of the machine apparatus and health to the operators.

Therefore, there is room for improvement in the art.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an assembled, isometric view of an embodiment of a machining apparatus.

FIG. 2 is similar to FIG. 1, but viewed from a different aspect.

FIG. 3 is another assembled, isometric view of the machining apparatus of FIG. 1, but without a rear plate.

FIG. 4 is similar to FIG. 3, but viewed from a different aspect.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

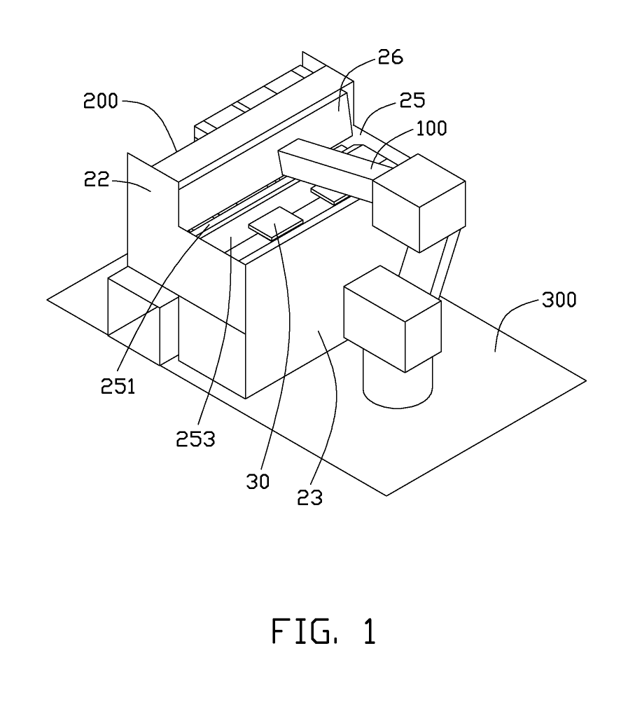

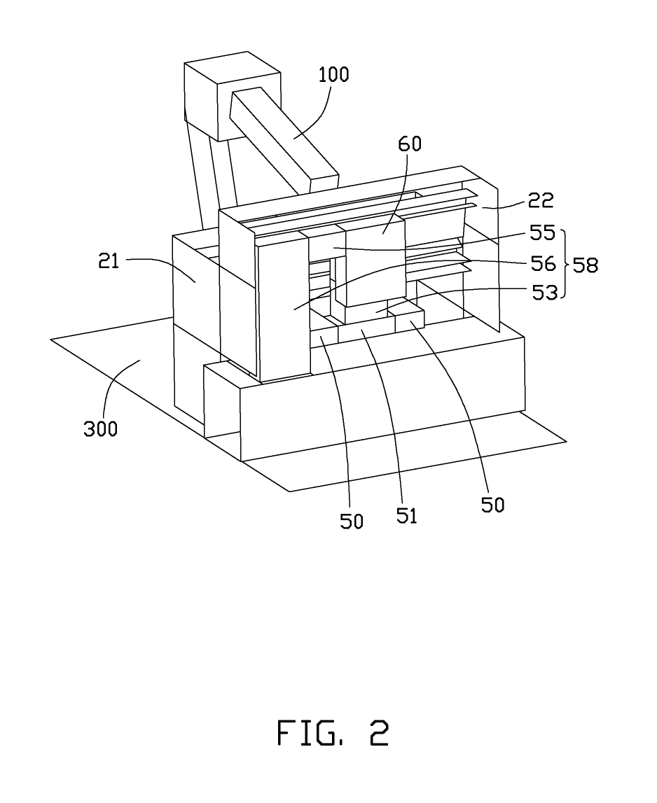

Referring to FIG. 1 and FIG. 2, a machining apparatus in accordance with an embodiment is shown. The machining apparatus comprises a robot 100 and a machine 200.

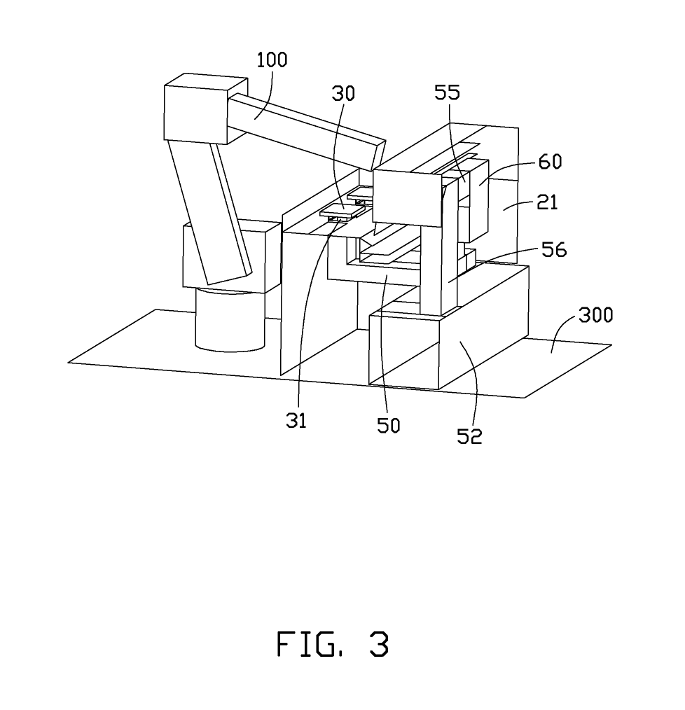

The machine 200 comprises a front plate 21, a rear plate 22, a top plate 25, a blocking plate 26, and a side plate 23 connected to the front plate 21 and the rear plate 22. In one embodiment, the front plate 21 is substantially parallel to the rear plate 22, the side plate 23 is substantially perpendicular to the front plate 21 and the rear plate 22, the top plate 25 is substantially perpendicular to the side plate 23 and the front plate 21, the blocking plate 26 is substantially parallel to the side plate 23. Two jigs 30 secured to the top plate 25, to secure a workpiece (not shown) to be processed. In one embodiment, the workpiece is a cover of a chassis. Each of the two jigs 30 defines a plurality of cutouts 31 (shown in FIG. 3) between a top surface of each of the two jigs 30 and the top plate 25. A limiting rib 251 protrudes from the top plate 25. In one embodiment, the limiting rib 251 is substantially perpendicular to the top plate 25. The side plate 23, the front plate 21 and the rear plate 22 extend upwardly out of the top plate 25. A receiving space 253 is defined by the side plate 23, the front plate 21, the rear plate 22, and the limiting rib 251 surrounded together. The receiving space 253 receives water.

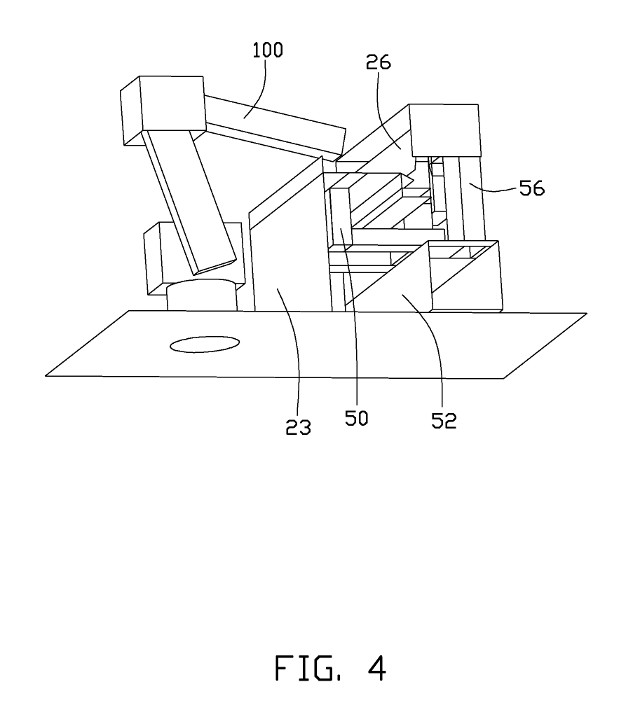

FIG. 3 and FIG. 4 illustrate two pipes 50 secured under the top plate 25 corresponding to the two jigs 30. Each of the two pipes 50 communicates with the plurality of cutouts 31 of each of the two jigs 30. The two pipes 50 communicate with each other via a connecting pipe 51. In one embodiment, each of the two pipes 50 is “L” shaped. The connecting pipe 51 communicates with a ventilation portion 58. The ventilation portion 58 comprises a first ventilation pipe 53, a second ventilation pipe 55, and a third ventilation pipe 56. Each of the two pipes 50 communicates with the first ventilation pipe 53. The first ventilation pipe 53 communicates with the second ventilation pipe 55. The second ventilation pipe 55 communicates with the third ventilation pipe 56. The machine 200 is secured to a base 300. An exhaust pipe 52 is secured to the base 300 and extends from the front plate 21 to the rear plate 22. The exhaust pipe 52 communicates with the third ventilation pipe 56. In one embodiment, the first ventilation pipe 53 is substantially perpendicular to the connecting pipe 51, the second ventilation pipe 55 is substantially perpendicular to the first ventilation pipe 53 and parallel to the connecting pipe 51, the third ventilation pipe 56 is substantially perpendicular to the second ventilation pipe 55 and the exhaust pipe 52. The third ventilation pipe 56 abuts the front plate 21. A fan 60 (only a case of the fan 60 is shown in FIG. 2) is secured between the second ventilation pipe 55 and the first ventilation pipe 53.

The robot 100 is secured on the outside of the side plate 23 and extends towards to the jigs 30. The robot 100 is used for polishing and cutting the workpiece. In this process, dust particles are generated around the jigs 30. The blocking plate 26 prevents the dust particles from diffusing out of the machine 200. A part of dust particles is dropped to the water in the receiving space 253. Another part of dust particles is sucked into each of the two pipes 50 and discharged out of the machine 200 via the connecting pipe 51, the first ventilation pipe 53, the second ventilation pipe 55, the third ventilation pipe 56 and the exhaust pipe 52. Thus, the dust particles cannot be collected in the machine 200.

It is to be understood, however, that even though numerous characteristics and advantages have been set forth in the foregoing description of embodiments, together with details of the structures and functions of the embodiments, the disclosure is illustrative only and changes may be made in detail, especially in matters of shape, size, and arrangement of parts within the principles of the disclosure to the full extent indicated by the broad general meaning of the terms in which the appended claims are expressed.

What is claimed is:

1. A machining apparatus comprising:
a machine comprises a top plate, a ventilation portion, a exhaust pipe, a fan, a pipe and a jig secured to the top plate, and the jig is configured for securing a workpiece to be processed; and
a robot configured for polishing and cutting the workpiece;
wherein the jig defines a cutout between a top surface of the jig and the top plate; the pipe communicates with the cutout; the ventilation portion communicates with the exhaust pipe and is located between the pipe and the exhaust pipe; the fan is secured to the ventilation portion; and the fan guides air flows into the pipe through the cutout and discharges the air out of the machine via the ventilation portion and the exhaust pipe.

2. The machining apparatus of claim 1, wherein the machine further comprises a front plate, a rear plate, a side plate, and a limiting rib secured to the top plate; the front plate is substantially parallel to the rear plate and perpendicular to the side plate; the front plate and the side plate are substantially perpendicular to the top plate; the front plate, the rear plate, the side plate, and the limiting rib cooperatively define a receiving space; and the receiving space receives water.

3. The machining apparatus of claim 2, wherein the front plate, the rear plate and the side plate extend out of the top plate, and the limiting rib is substantially perpendicular to the top plate.

4. The machining apparatus of claim 2, wherein the machine further comprises a blocking plate substantially parallel to the side plate, and the blocking plate is configured to prevent dust particles from the workpiece from diffusing out of the machine.

5. The machining apparatus of claim 4, wherein the ventilation portion comprises a first ventilation pipe, a second ventilation pipe, and a third ventilation pipe; the second ventilation pipe is between the first ventilation pipe and the third ventilation pipe; the first ventilation pipe communicates with the pipe, and the third ventilation pipe communicates with the exhaust pipe.

6. The machining apparatus of claim 5, wherein the first ventilation pipe is substantially perpendicular to the pipe, and the second ventilation pipe is substantially perpendicular to the third ventilation pipe.

7. The machining apparatus of claim 5, wherein the third ventilation pipe is substantially perpendicular to the exhaust pipe.

8. The machining apparatus of claim 5, wherein the third ventilation pipe abuts the front plate and the blocking plate and is located between the front plate and the rear plate.

9. The machining apparatus of claim 1, wherein further comprising a base, wherein the machine is secured to the base, and the exhaust pipe is secured to the base and extends from the front plate to the rear plate.

10. A machining apparatus comprising:
a machine comprises a top plate, a ventilation portion, a exhaust pipe, a fan, a pipe and a jig secured to the top plate, and the jig is configured for securing a workpiece to be processed; and
a robot configured for polishing and cutting the workpiece;
wherein the machine further comprises a front plate, a rear plate, a side plate, and a limiting rib secured to the top plate; the front plate, the rear plate, the side plate, and the limiting rib cooperatively define a receiving space, and the receiving space receives water; the jig defines a cutout between a top surface of the jig and the top plate; the pipe communicates with the cutout; the ventilation portion communicates with the exhaust pipe and is located between the pipe and the exhaust pipe; the fan is secured to the ventilation portion; and the fan guides air to flow into the pipe through the cutout and discharges the air out of the machine via the ventilation portion and the exhaust pipe.

11. The machining apparatus of claim 10, wherein the front plate is substantially parallel to the rear plate and perpendicular to the side plate; the front plate and the side plate are substantially perpendicular to the top plate.

12. The machining apparatus of claim 10, wherein the front plate, the rear plate and the side plate extend out of the top plate, and the limiting rib is substantially perpendicular to the top plate.

13. The machining apparatus of claim 10, wherein the machine further comprises a blocking plate substantially parallel to the side plate, and the blocking plate is configured to prevent dust particles from workpiece from diffusing outside of the machine.

14. The machining apparatus of claim 13, wherein the ventilation portion comprises a first ventilation pipe, a second ventilation pipe, and a third ventilation pipe; the second ventilation pipe is between the first ventilation pipe and the third ventilation pipe; the first ventilation pipe communicates with the pipe, and the third ventilation pipe communicates with the exhaust pipe.

15. The machining apparatus of claim 14, wherein the first ventilation pipe is substantially perpendicular to the pipe, and the second ventilation pipe is substantially perpendicular to the third ventilation pipe.

16. The machining apparatus of claim 14, wherein the third ventilation pipe is substantially perpendicular to the exhaust pipe.

17. The machining apparatus of claim 14, wherein the third ventilation pipe abuts the front plate and the blocking plate and is located between the front plate and the rear plate.

18. The machining apparatus of claim 10, wherein further comprising a base, wherein the machine is secured to the base, and the exhaust pipe is secured to the base and extends from the front plate to the rear plate.
